(19) United States
(12) Patent Application Publication
(10) Pub. No.: US 2024/0278795 A1
(43) Pub. Date: Aug. 22, 2024

(54) ONE-PEDAL DRIVING

(71) Applicant: GM Global Technology Operations LLC, Detroit, MI (US)

(72) Inventors: Mohamed A. Layouni, Fraser, MI (US); Mohamed A. Naiel, Ajax (CA)

(21) Appl. No.: 18/170,823

(22) Filed: Feb. 17, 2023

(51) Int. Cl. B60W 50/10

(52) U.S. Cl. CPC B60W 50/10; B60W 30/08; B60W 30/18154; B60W 2520/105; B60W 2540/103; B60W 2540/12; B60W 2540/215; B60W 2555/60; B60W 2720/106

(57) ABSTRACT

A system for controlling acceleration of a vehicle includes a plurality of vehicle sensors and a controller in electrical communication with the plurality of vehicle sensors. The controller is programmed to determine an accelerator pedal activation state. The accelerator pedal activation state includes an accelerator pedal activated state and an accelerator pedal deactivated state. The controller is further programmed to identify an accelerator pedal activation stimulus in response to determining that the accelerator pedal activation state is the accelerator pedal deactivated state. The accelerator pedal activation stimulus is identified using the plurality of vehicle sensors. The controller is further programmed to determine the accelerator pedal activation state to be the accelerator pedal activated state in response to identifying the accelerator pedal activation stimulus.

### INTRODUCTION

The present disclosure relates to systems and methods for one-pedal driving, and more specifically, to systems and methods for one-pedal control for a vehicle.

To increase efficiency and convenience, vehicles may be equipped with one-pedal driving systems. One-pedal driving systems allow occupants to control acceleration and deceleration of the vehicle using only one foot-operated pedal, for example, an accelerator pedal. When the accelerator pedal is depressed, the vehicle accelerates. When the accelerator pedal is released, the vehicle decelerates. One-pedal driving systems may be configured to allow complete deceleration to a stand-still, such that the occupant may drive the vehicle using only the accelerator pedal. However, current one-pedal driving systems may not account for the possibility of unintended actuation of the accelerator pedal by the occupant, resulting in acceleration of the vehicle.

Thus, while current one-pedal driving systems and methods achieve their intended purpose, there is a need for a new and improved system and method for controlling acceleration of a vehicle.

### SUMMARY

According to several aspects, a system for controlling acceleration of a vehicle is provided. The system includes a plurality of vehicle sensors and a controller in electrical communication with the plurality of vehicle sensors. The controller is programmed to determine an accelerator pedal activation state. The accelerator pedal activation state includes an accelerator pedal activated state and an accelerator pedal deactivated state. The controller is further programmed to identify an accelerator pedal activation stimulus in response to determining that the accelerator pedal activation state is the accelerator pedal deactivated state. The accelerator pedal activation stimulus is identified using the plurality of vehicle sensors. The controller is further programmed to determine the accelerator pedal activation state to be the accelerator pedal activated state in response to identifying the accelerator pedal activation stimulus.

In another aspect of the present disclosure, to determine the accelerator pedal activation state, the controller is further programmed to determine a first elapsed time for which a vehicle speed has been less than or equal to a predetermined minimum vehicle speed threshold using the plurality of vehicle sensors. To determine the accelerator pedal activation state, the controller is further programmed to compare the first elapsed time to a first predetermined elapsed time threshold. To determine the accelerator pedal activation state, the controller is further programmed to determine the accelerator pedal activation state to be the accelerator pedal deactivated state in response to determining that the first elapsed time is greater than or equal to the first predetermined elapsed time threshold.

In another aspect of the present disclosure, to identify the accelerator pedal activation stimulus, the controller is further programmed to identify at least one of a first manual accelerator pedal activation stimulus, a second manual accelerator pedal activation stimulus, a third manual accelerator pedal activation stimulus, and an automatic accelerator pedal activation stimulus.

In another aspect of the present disclosure, the plurality of vehicle sensors further includes an accelerator pedal position sensor. To identify the accelerator pedal activation stimulus, the controller is further programmed to identify the first manual accelerator pedal activation stimulus using at least the accelerator pedal position sensor.

In another aspect of the present disclosure, to identify the first manual accelerator pedal activation stimulus, the controller is further programmed to perform a plurality of accelerator pedal position measurements using the accelerator pedal position sensor. To identify the first manual accelerator pedal activation stimulus, the controller is further programmed to identify a first accelerator pedal event based on the plurality of accelerator pedal position measurements. During the first accelerator pedal event, an accelerator pedal position is greater than or equal to a first predetermined accelerator pedal position threshold for at least a first predetermined time duration. To identify the first manual accelerator pedal activation stimulus, the controller is further programmed to identify a second accelerator pedal event in response to identifying the first accelerator pedal event. The second accelerator pedal event occurs after the first accelerator pedal event. The second accelerator pedal event is identified based on the plurality of accelerator pedal position measurements. During the second accelerator pedal event, the accelerator pedal position is less than or equal to a predetermined minimum accelerator pedal position threshold for at least a second predetermined time duration. To identify the first manual accelerator pedal activation stimulus, the controller is further programmed to identify a third accelerator pedal event in response to identifying the second accelerator pedal event. The third accelerator pedal event occurs after the second accelerator pedal event. The third accelerator pedal event is identified based on the plurality of accelerator pedal position measurements. During the third accelerator pedal event, the accelerator pedal position is greater than or equal to the first predetermined accelerator pedal position threshold for at least the first predetermined time duration. To identify the first manual accelerator pedal activation stimulus, the controller is further programmed to determine a first elapsed time between the first accelerator pedal event and the third accelerator pedal event. To identify the first manual accelerator pedal activation stimulus, the controller is further programmed to identify the first manual accelerator pedal activation stimulus in response to determining that the first elapsed time is less than or equal to a first predetermined elapsed time threshold.

In another aspect of the present disclosure, the plurality of vehicle sensors further includes a brake pedal position sensor. To identify the accelerator pedal activation stimulus, the controller is further programmed to identify the second manual accelerator pedal activation stimulus using at least the brake pedal position sensor.

In another aspect of the present disclosure, to identify the second manual accelerator pedal activation stimulus, the controller is further programmed to perform a brake pedal position measurement using the brake pedal position sensor. To identify the second manual accelerator pedal activation stimulus, the controller is further programmed to compare the brake pedal position measurement to a predetermined brake pedal position threshold. To identify the second manual accelerator pedal activation stimulus, the controller is further programmed to perform an accelerator pedal position measurement using the accelerator pedal position sensor in response to determining that the brake pedal position measurement is greater than or equal to the predetermined brake pedal position threshold. To identify the second manual accelerator pedal activation stimulus, the controller is further programmed to compare the accelerator pedal position measurement to a predetermined minimum accelerator pedal position threshold. To identify the second manual accelerator pedal activation stimulus, the controller is further programmed to determine a second elapsed time between the brake pedal position measurement and the accelerator pedal position measurement in response to determining that the accelerator pedal position measurement is greater than the predetermined minimum accelerator pedal position threshold. To identify the second manual accelerator pedal activation stimulus, the controller is further programmed to compare the second elapsed time to a second predetermined elapsed time threshold. To identify the second manual accelerator pedal activation stimulus, the controller is further programmed to identify the second manual accelerator pedal activation stimulus in response to determining that the second elapsed time is less than or equal to the second predetermined elapsed time threshold.

In another aspect of the present disclosure, the plurality of vehicle sensors further includes an occupant-controlled switch. To identify the accelerator pedal activation stimulus, the controller is further programmed to identify the third manual accelerator pedal activation stimulus using at least the occupant-controlled switch.

In another aspect of the present disclosure, to identify the third manual accelerator pedal activation stimulus, the controller is further programmed to perform an accelerator pedal position measurement using the accelerator pedal position sensor. To identify the third manual accelerator pedal activation stimulus, the controller is further programmed to compare the accelerator pedal position measurement to a predetermined minimum accelerator pedal position threshold. To identify the third manual accelerator pedal activation stimulus, the controller is further programmed to determine a switch activation status of the occupant-controlled switch. The switch activation status includes a switch activated status and a switch deactivated status. To identify the third manual accelerator pedal activation stimulus, the controller is further programmed to identify the third manual accelerator pedal activation stimulus in response to determining that the accelerator pedal position measurement is greater than or equal to the predetermined minimum accelerator pedal position threshold and that the switch activation status is the switch activated status.

In another aspect of the present disclosure, the plurality of vehicle sensors further includes at least one perception sensor. To identify the automatic accelerator pedal activation stimulus, the controller is further programmed to perform at least one perception measurement using the at least one perception sensor. To identify the automatic accelerator pedal activation stimulus, the controller is further programmed to determine an obstacle obstruction state based on the at least one perception measurement. The obstacle obstruction state includes an obstructed state and an unobstructed state. To identify the automatic accelerator pedal activation stimulus, the controller is further programmed to determine a traffic signal state based on the at least one perception measurement. The traffic signal state includes a stop traffic signal state and a go traffic signal state. To identify the automatic accelerator pedal activation stimulus, the controller is further programmed to identify the automatic accelerator pedal activation stimulus in response to determining that the obstacle obstruction state is the unobstructed state and the traffic signal state is the go traffic signal state.

According to several aspects, a method for controlling acceleration of a vehicle is provided. The method includes determining a first elapsed time for which a vehicle speed has been less than or equal to a predetermined minimum vehicle speed threshold using a plurality of vehicle sensors. The method also includes comparing the first elapsed time to a first predetermined elapsed time threshold. The method also includes determining an accelerator pedal activation state to be an accelerator pedal deactivated state in response to determining that the first elapsed time is greater than or equal to the first predetermined elapsed time threshold. The method also includes identifying an accelerator pedal activation stimulus in response to determining that the accelerator pedal activation state is the accelerator pedal deactivated state. The accelerator pedal activation stimulus is identified using the plurality of vehicle sensors. The method also includes determining the accelerator pedal activation state to be an accelerator pedal activated state in response to identifying the accelerator pedal activation stimulus.

In another aspect of the present disclosure, identifying the accelerator pedal activation stimulus further may include identifying at least one of a manual accelerator pedal activation stimulus and an automatic accelerator pedal activation stimulus.

In another aspect of the present disclosure, the manual accelerator pedal activation stimulus further may include at least one of: a first manual accelerator pedal activation stimulus, a second manual accelerator pedal activation stimulus, and a third manual accelerator pedal activation stimulus. The first manual accelerator pedal activation stimulus is identified using at least an accelerator pedal position sensor. The second manual accelerator pedal activation stimulus is identified using at least a brake pedal position sensor. The third manual accelerator pedal activation stimulus is identified using at least an occupant-controlled switch.

In another aspect of the present disclosure, identifying the first manual accelerator pedal activation stimulus further may include performing a plurality of accelerator pedal position measurements using the accelerator pedal position sensor. Identifying the first manual accelerator pedal activation stimulus further may include identifying a first accelerator pedal event based on the plurality of accelerator pedal position measurements. During the first accelerator pedal event, an accelerator pedal position is greater than or equal to a first predetermined accelerator pedal position threshold for at least a first predetermined time duration. Identifying the first manual accelerator pedal activation stimulus further may include identifying a second accelerator pedal event in response to identifying the first accelerator pedal event. The second accelerator pedal event occurs after the first accelerator pedal event. The second accelerator pedal event is identified based on the plurality of accelerator pedal position measurements. During the second accelerator pedal event, the accelerator pedal position is less than or equal to a predetermined minimum accelerator pedal position threshold for at least a second predetermined time duration. Identifying the first manual accelerator pedal activation stimulus further may include identifying a third accelerator pedal event in response to identifying the second accelerator pedal event. The third accelerator pedal event occurs after the second accelerator pedal event. The third accelerator pedal event is identified based on the plurality of accelerator pedal position measurements. During the third accelerator pedal event, the accelerator pedal position is greater than or equal to the first predetermined accelerator pedal position threshold for at least the first predetermined time duration. Identifying the first manual accelerator pedal activation stimulus further may include determining a first elapsed time between the first accelerator pedal event and the third accelerator pedal event. Identifying the first manual accelerator pedal activation stimulus further may include identifying the first manual accelerator pedal activation stimulus in response to determining that the first elapsed time is less than or equal to a first predetermined elapsed time threshold.

In another aspect of the present disclosure, identifying the second manual accelerator pedal activation stimulus further may include performing a brake pedal position measurement using the brake pedal position sensor. Identifying the second manual accelerator pedal activation stimulus further may include comparing the brake pedal position measurement to a predetermined brake pedal position threshold. Identifying the second manual accelerator pedal activation stimulus further may include performing an accelerator pedal position measurement using the accelerator pedal position sensor in response to determining that the brake pedal position measurement is greater than or equal to the predetermined brake pedal position threshold. Identifying the second manual accelerator pedal activation stimulus further may include comparing the accelerator pedal position measurement to a predetermined minimum accelerator pedal position threshold. Identifying the second manual accelerator pedal activation stimulus further may include determining a second elapsed time between the brake pedal position measurement and the accelerator pedal position measurement in response to determining that the accelerator pedal position measurement is greater than the predetermined minimum accelerator pedal position threshold. Identifying the second manual accelerator pedal activation stimulus further may include comparing the second elapsed time to a second predetermined elapsed time threshold. Identifying the second manual accelerator pedal activation stimulus further may include identifying the second manual accelerator pedal activation stimulus in response to determining that the second elapsed time is less than or equal to the second predetermined elapsed time threshold.

In another aspect of the present disclosure, identifying the third manual accelerator pedal activation stimulus further may include performing an accelerator pedal position measurement using the accelerator pedal position sensor. Identifying the third manual accelerator pedal activation stimulus further may include comparing the accelerator pedal position measurement to a predetermined minimum accelerator pedal position threshold. Identifying the third manual accelerator pedal activation stimulus further may include determining a switch activation status of the occupant-controlled switch. The switch activation status includes a switch activated status and a switch deactivated status. Identifying the third manual accelerator pedal activation stimulus further may include identifying the third manual accelerator pedal activation stimulus in response to determining that the accelerator pedal position measurement is greater than or equal to the predetermined minimum accelerator pedal position threshold and that the switch activation status is the switch activated status.

In another aspect of the present disclosure, identifying the automatic accelerator pedal activation stimulus further may include performing at least one perception measurement using at least one perception sensor. Identifying the automatic accelerator pedal activation stimulus further may include determining an obstacle obstruction state based on the at least one perception measurement. The obstacle obstruction state includes an obstructed state and an unobstructed state. Identifying the automatic accelerator pedal activation stimulus further may include determining a traffic signal state based on the at least one perception measurement. The traffic signal state includes a stop traffic signal state and a go traffic signal state. Identifying the automatic accelerator pedal activation stimulus further may include identifying the automatic accelerator pedal activation stimulus in response to determining that the obstacle obstruction state is the unobstructed state and the traffic signal state is the go traffic signal state.

According to several aspects, a system for controlling acceleration of a vehicle is provided. The system includes a plurality of vehicle sensors. The plurality of vehicle sensors includes an accelerator pedal position sensor, a brake pedal position sensor, an occupant-controlled switch, and at least one perception sensor. The system also includes a controller in electrical communication with the plurality of vehicle sensors. The controller is programmed to determine a first elapsed time for which a vehicle speed has been less than or equal to a predetermined minimum vehicle speed threshold using the plurality of vehicle sensors. The controller is further programmed to compare the first elapsed time to a first predetermined elapsed time threshold. The controller is further programmed to determine an accelerator pedal activation state to be an accelerator pedal deactivated state in response to determining that the first elapsed time is greater than or equal to the first predetermined elapsed time threshold. The controller is further programmed to identify an accelerator pedal activation stimulus in response to determining that the accelerator pedal activation state is the accelerator pedal deactivated state. The accelerator pedal activation stimulus includes at least one of a manual accelerator pedal activation stimulus and an automatic accelerator pedal activation stimulus. The manual accelerator pedal activation stimulus is identified using at least one of the accelerator pedal position sensor, the brake pedal position sensor, and the occupant-controlled switch. The automatic accelerator pedal activation stimulus is identified using at least the at least one perception sensor. The controller is further programmed to determine the accelerator pedal activation state to be an accelerator pedal activated state in response to identifying the accelerator pedal activation stimulus.

In another aspect of the present disclosure, the manual accelerator pedal activation stimulus further includes at least one of a first manual accelerator pedal activation stimulus, a second manual accelerator pedal activation stimulus, and a third manual accelerator pedal activation stimulus. The first manual accelerator pedal activation stimulus is identified using at least the accelerator pedal position sensor. The second manual accelerator pedal activation stimulus is identified using at least the brake pedal position sensor. The third manual accelerator pedal activation stimulus is identified using at least the occupant-controlled switch.

In another aspect of the present disclosure, to identify the automatic accelerator pedal activation stimulus, the controller is further programmed to perform at least one perception measurement using the at least one perception sensor. To identify the automatic accelerator pedal activation stimulus, the controller is further programmed to determine an obstacle obstruction state based on the at least one perception measurement. The obstacle obstruction state includes an obstructed state and an unobstructed state. To identify the automatic accelerator pedal activation stimulus, the controller is further programmed to determine a traffic signal state based on the at least one perception measurement. The traffic signal state includes a stop traffic signal state and a go traffic signal state. To identify the automatic accelerator pedal activation stimulus, the controller is further programmed to identify the automatic accelerator pedal activation stimulus in response to determining that the obstacle obstruction state is the unobstructed state and the traffic signal state is the go traffic signal state.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for controlling acceleration of a vehicle, according to an exemplary embodiment;

FIG. 2 is a flowchart of a method for controlling acceleration of a vehicle, according to an exemplary embodiment; and

FIG. 3 is a flowchart of a method for identifying a manual accelerator pedal activation stimulus, according to an exemplary embodiment.

### DETAILED DESCRIPTION

The following description is merely exemplary in nature and is not intended to limit the present disclosure, application, or uses.

When using a one-pedal driving system in a vehicle, occupants may be inclined to rest a foot on or near the accelerator pedal of the vehicle when the vehicle is not in motion. Therefore, there is a possibility of unintended actuation of the accelerator pedal and thus acceleration of the vehicle. The system 10 and method 100 of the present disclosure are used to control acceleration of the vehicle when using one-pedal driving.

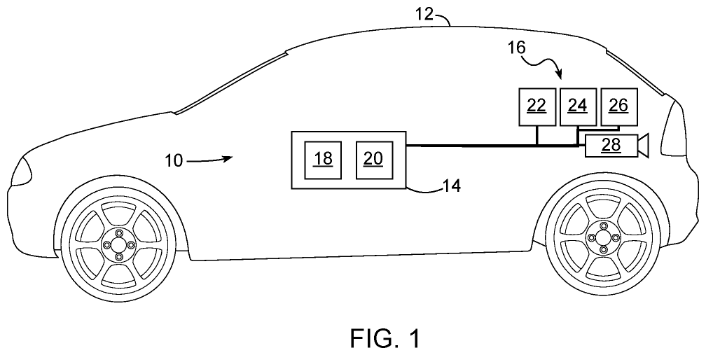

Referring to FIG. 1, a system for controlling acceleration of a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14 and a plurality of vehicle sensors 16.

The controller 14 is used to implement a method 100 for controlling acceleration of a vehicle, as will be described below. The controller 14 includes at least one processor 18 and a non-transitory computer readable storage device or media 20. The processor 18 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. The computer readable storage device or media 20 may include volatile and nonvolatile storage in read-only memory (ROM), random-access memory (RAM), and keep-alive memory (KAM), for example. KAM is a persistent or non-volatile memory that may be used to store various operating variables while the processor 18 is powered down. The computer-readable storage device or media 20 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other.

The controller 14 is in electrical communication with the plurality of vehicle sensors 16. In an exemplary embodiment, the electrical communication is established using, for example, a CAN bus, a Wi-Fi network, a cellular data network, or the like. It should be understood that various additional wired and wireless techniques and communication protocols for communicating with the controller 14 are within the scope of the present disclosure.

The plurality of vehicle sensors 16 are used to measure control inputs of the vehicle 12 and gather information about an environment surrounding the vehicle 12. In an exemplary embodiment, the plurality of vehicle sensors 16 includes an accelerator pedal position sensor 22, a brake pedal position sensor 24, and occupant-controlled switch 26, and a perception sensor 28. In another exemplary embodiment, the plurality of vehicle sensors 16 further includes sensors for determining characteristics of the vehicle 12. In a non-limiting example, the plurality of vehicle sensors 16 further includes at least one of: a motor speed sensor, a motor torque sensor, an electric drive motor voltage and/or current sensor, a vehicle speed sensor, a coolant temperature sensor, a cooling fan speed sensor, and/or a transmission oil temperature sensor. The plurality of vehicle sensors 16 is in electrical communication with the controller 14 as discussed above.

The accelerator pedal position sensor 22 is used to measure a position of an accelerator pedal of the vehicle 12. In an exemplary embodiment, the accelerator pedal position sensor 22 is an electro-mechanical sensor which converts a mechanical movement of the accelerator pedal into an electrical signal. In a non-limiting example, the accelerator pedal position sensor 22 includes a potentiometer having at least a first terminal electrically connected to a wiper, and a second terminal. The wiper of the potentiometer is affixed (e.g., by way of a mechanical linkage, a gearset, and/or the like) to the accelerator pedal. Therefore, an electrical resistance measured between the first terminal (i.e., the wiper) and the second terminal is proportional to a position of the accelerator pedal. Accordingly, by measuring the electrical resistance between the first terminal and the second terminal of the potentiometer, the controller 14 determines a position of the accelerator pedal. It should be understood that additional sensors for measuring a position of the accelerator pedal (e.g., rotary encoders, proximity sensors, and the like) are within the scope of the present disclosure.

The brake pedal position sensor 24 is used to measure a position of a brake pedal of the vehicle 12. In an exemplary embodiment, the brake pedal position sensor 24 is an electro-mechanical sensor which converts a mechanical movement of the brake pedal into an electrical signal. In a non-limiting example, the brake pedal position sensor 24 includes a potentiometer having at least a first terminal electrically connected to a wiper, and a second terminal. The wiper of the potentiometer is connected (e.g., by way of a mechanical linkage, a gearset, and/or the like) to the brake pedal. Therefore, an electrical resistance measured between the first terminal (i.e., the wiper) and the second terminal is proportional to a position of the brake pedal. Accordingly, by measuring the electrical resistance between the first terminal and the second terminal of the potentiometer, the controller 14 determines a position of the brake pedal. It should be understood that additional sensors for measuring a position of the brake pedal (e.g., rotary encoders, proximity sensors, and the like) are within the scope of the present disclosure.

The occupant-controlled switch 26 is used to receive input from the occupant of the vehicle 12. In an exemplary embodiment, the occupant-controlled switch 26 is one of: a touchscreen, an electromechanical switch, a capacitive switch, or the like. In a non-limiting example, the occupant-controlled switch 26 is affixed to a steering wheel of the vehicle 12, such that the occupant-controlled switch 26 may be easily activated by the occupant of the vehicle 12. The occupant-controlled switch 26 is in electrical communication with the controller 14 as discussed above.

The perception sensor 28 is used to gather information about the environment surrounding the vehicle 12. In an exemplary embodiment, the perception sensor includes at least one of: a ranging perception sensor and/or a visual perception sensor. In a non-limiting example, the ranging perception sensor includes, for example, a LiDAR sensor, an ultrasonic ranging sensor, a radar sensor, a time-of-flight sensor, and/or the like. In a non-limiting example, the visual perception sensor includes, for example, an exterior camera, a surround view camera system, a stereoscopic camera, and/or the like. In the exemplary embodiment shown in FIG. 1, the perception sensor 28 is a surround view camera system. The surround view camera system includes a plurality of cameras (also known as satellite cameras) arranged to provide a view of the environment adjacent to all sides of the vehicle 12. In a non-limiting example, the surround view camera system includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the surround view camera system further includes an additional rear-view camera mounted near a center high mounted stop lamp of the vehicle 12.

It should be understood that surround view camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

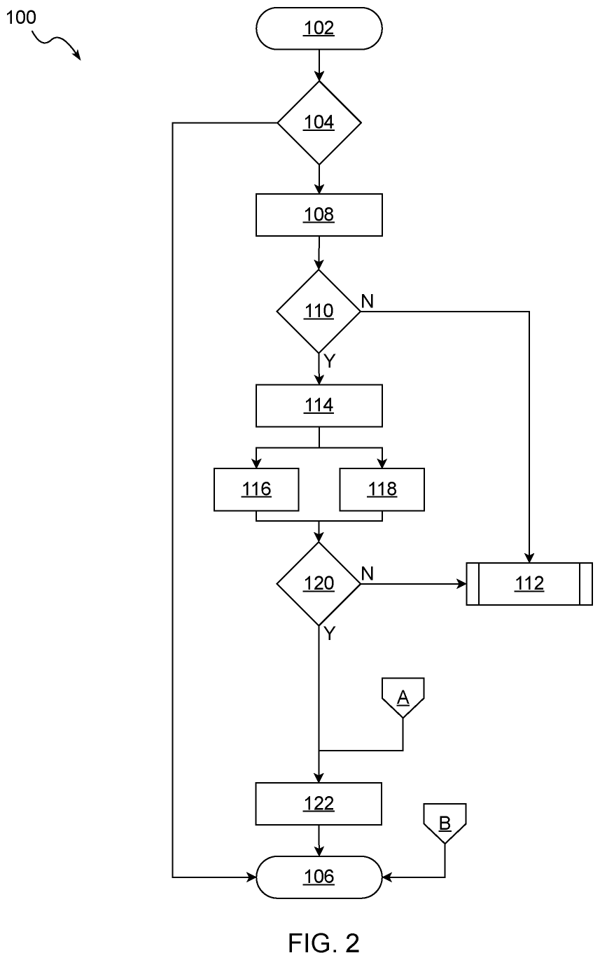

Referring to FIG. 2, a flowchart of the method 100 for controlling acceleration of a vehicle is shown. The method 100 begins at block 102 and proceeds to block 104. At block 104, the controller 14 determines an accelerator pedal activation state. In the scope of the present disclosure, the accelerator pedal activation state includes an accelerator pedal activated state and an accelerator pedal deactivated state. If the accelerator pedal activation state is the accelerator pedal activated state, a power level of a powertrain of the vehicle 12 (and thus an acceleration of the vehicle 12) is controlled based on a position of the accelerator pedal as determined by the accelerator pedal position sensor 22. If the accelerator pedal activation state is the accelerator pedal deactivated state, the position of the accelerator pedal has no effect on the power level of the powertrain of the vehicle 12. In other words, when the accelerator pedal activation state is the accelerator pedal activated state, the accelerator pedal may be actuated by the occupant of the vehicle 12 to control an acceleration of the vehicle 12. When the accelerator pedal activation state is the accelerator pedal deactivated state, the accelerator pedal has no effect on the acceleration of the vehicle 12, regardless of actuation of the accelerator pedal by the occupant of the vehicle 12.

In an exemplary embodiment, to determine the accelerator pedal activation state, the controller 14 uses the plurality of vehicle sensors 16 to determine a vehicle speed of the vehicle 12. The vehicle speed is then compared to a predetermined minimum vehicle speed threshold (e.g., 0.5 miles per hour). If the vehicle speed is less than or equal to the predetermined minimum vehicle speed threshold, a first elapsed time for which the vehicle speed has been less than or equal to the predetermined minimum vehicle speed threshold is determined. The first elapsed time is then compared to a first predetermined elapsed time threshold (e.g., three seconds). If the first elapsed time is less than the first predetermined elapsed time threshold, the method 100 proceeds to enter a standby state at block 106. If the first elapsed time is greater than or equal to the first predetermined elapsed time threshold, the method 100 proceeds to block 108. At block 108, the accelerator pedal activation state is determined to be the accelerator pedal deactivated state. In an exemplary embodiment, in response to determining that the accelerator pedal activation state is the accelerator pedal deactivated state, the controller 14 uses a human-machine interface (e.g., a vehicle infotainment system, a touchscreen, a head-up display, and/or the like) to notify the occupant that the accelerator pedal activation state is the accelerator pedal deactivated state. In a non-limiting example, the occupant may be notified using visual notifications (i.e., notifications shown on the human-machine interface (not shown) of the vehicle 12), haptic notifications (e.g., notifications provided by a vibrating seat (not shown) and/or vibrating steering wheel (not shown) of the vehicle 12), and/or auditory notifications (e.g., notifications provided by a speaker (not shown) of the vehicle 12). After block 108, the method 100 proceeds to block 110.

In order to change the accelerator pedal activation state from the accelerator pedal deactivated state to the accelerator pedal activated state, the controller 14 identifies an accelerator pedal activation stimulus. In the scope of the present disclosure, the accelerator pedal activation stimulus is an event which signals to change the accelerator pedal activation state from the accelerator pedal deactivated state to the accelerator pedal activated state. In an exemplary embodiment, the accelerator pedal activation stimulus includes at least one of: a manual accelerator pedal activation stimulus and an automatic accelerator pedal activation stimulus.

At block 110, the controller 14 determines whether an automatic activation stimulus mode is activated. In an exemplary embodiment, the automatic activation stimulus mode is controlled by the occupant of the vehicle 12, using a human-interface device (e.g., a touchscreen, an electromechanical button, and/or the like). If the automatic activation stimulus mode is deactivated, the accelerator pedal activation state may be changed based on the manual accelerator pedal activation stimulus, and the method 100 proceeds to block 112. If the automatic activation stimulus mode is activated, the accelerator pedal activation state may be changed based on the automatic accelerator pedal activation stimulus, and the method 100 proceeds to block 114.

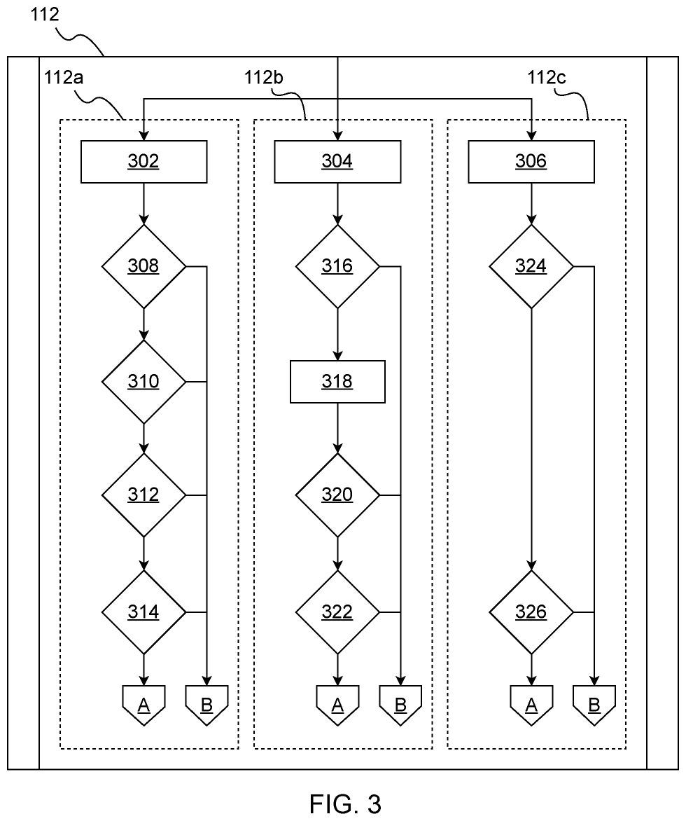

At block 112, the controller 14 identifies the manual accelerator pedal activation stimulus, as will be discussed in greater detail below in reference to FIG. 3.

At block 114, the controller 14 uses the perception sensor 28 to perform at least one perception measurement of the environment surrounding the vehicle 12. In an exemplary embodiment, the controller 14 uses the surround view camera system to capture at least one image of the environment surrounding the vehicle 12. After block 114, the method 100 proceeds to blocks 116 and 118.

At block 116, the controller 14 analyzes the at least one perception measurement performed at block 114 to determine an obstacle obstruction state. In the scope of the present disclosure, the obstacle obstruction state includes an obstructed state and an unobstructed state. The obstructed state means that the perception measurement performed at block 114 indicates that an object (e.g., a remote vehicle, a pedestrian, a traffic cone, a median barrier, a barrier gate, and/or the like) is detected in an immediate path of the vehicle 12 (e.g., within 5 meters directly in front of the vehicle 12). The unobstructed state means that no objects are detected in the immediate path of the vehicle 12.

In an exemplary embodiment, the perception measurement is at least one image captured by the surround view camera system. To determine the obstacle obstruction state, the controller 14 analyzes the at least one image using a computer vision algorithm to identify objects in the immediate path of the vehicle 12. In a non-limiting example, the computer vision algorithm includes a machine learning algorithm which has been trained to identify obstacles in the immediate path of the vehicle 12. The machine learning algorithm is trained by providing the algorithm with a plurality of images which have been pre-classified. For example, the plurality of images may include images of various driving environments including obstacles in the immediate path of the vehicle 12 and various driving environments without obstacles in the immediate path of the vehicle 12. After sufficient training of the machine learning algorithm, the algorithm can identify obstacles in the immediate path of the vehicle 12 with a high accuracy and precision. After block 116, the method 100 proceeds to block 120.

At block 118, the controller 14 analyzes the at least one perception measurement performed at block 114 to determine a traffic signal state. In the scope of the present disclosure, the traffic signal state includes a stop traffic signal state and a go traffic signal state. The stop traffic signal state means that the perception measurement performed at block 114 indicates that a red traffic light is detected in the immediate path of the vehicle 12. The go traffic signal state means that no red traffic light is detected in the immediate path of the vehicle 12.

In an exemplary embodiment, the perception measurement is at least one image captured by the surround view camera system. To determine the traffic signal state, the controller 14 analyzes the at least one image using a computer vision algorithm to identify traffic signals in the immediate path of the vehicle 12. In a non-limiting example, the computer vision algorithm includes a machine learning algorithm which has been trained to identify traffic signals in the immediate path of the vehicle 12. The machine learning algorithm is trained by providing the algorithm with a plurality of images which have been pre-classified. For example, the plurality of images may include images of various driving environments including traffic signals having red lights illuminated, traffic signals having yellow lights illuminated, and traffic signals having green lights illuminated, as well as various driving environments having no traffic signals. After sufficient training of the machine learning algorithm, the algorithm can identify traffic signals in the immediate path of the vehicle 12 with a high accuracy and precision. After block 118, the method 100 proceeds to block 120.

At block 120, if the obstacle obstruction state is the unobstructed state and the traffic signal state is the go traffic signal state, the automatic accelerator pedal activation stimulus is identified, and the method 100 proceeds to block 122. If the obstacle obstruction state is the obstructed state or the traffic signal state is the stop traffic signal state, the automatic accelerator pedal activation stimulus is not identified. The controller 14 uses a human-machine interface (e.g., a vehicle infotainment system, a touchscreen, a head-up display, vibrating seat, vibrating steering wheel, speaker, and/or the like) to notify the occupant that the automatic accelerator pedal activation stimulus is not identified, and the method 100 proceeds to block 112. Therefore, if the automatic accelerator pedal activation stimulus is not identified, the method 100 proceeds to identify the manual accelerator pedal activation stimulus at block 112, thus allowing the occupant to move the vehicle 12 even if the automatic accelerator pedal activation stimulus is not identified.

At block 122, the accelerator pedal activation state is determined to be the accelerator pedal activated state, such that the power level of the powertrain of the vehicle 12 (and thus an acceleration of the vehicle 12) is controlled based on the position of the accelerator pedal as determined by the accelerator pedal position sensor 22. After block 122, the method 100 proceeds to enter the standby state at block 106.

In an exemplary embodiment, the controller 14 repeatedly exits the standby state 106 and restarts the method 100 at block 102. In a non-limiting example, the controller 14 exits the standby state 106 and restarts the method 100 on a timer, for example, every three hundred milliseconds.

Referring to FIG. 3, a flowchart of an exemplary embodiment of block 112 is shown. The exemplary embodiment of block 112 provides a method 112a for identifying a first manual accelerator pedal activation stimulus, a method 112b for identifying a second manual accelerator pedal activation stimulus, and a method 112c for identifying a third accelerator pedal activation stimulus, as will be discussed in greater detail below. In an exemplary embodiment, the first manual accelerator pedal activation stimulus includes the occupant actuating the accelerator pedal, releasing the accelerator pedal, and actuating the accelerator pedal once more. The second manual accelerator pedal activation stimulus includes the occupant actuating the brake pedal and subsequently actuating the accelerator pedal. The third accelerator pedal activation stimulus includes the occupant actuating the accelerator pedal and simultaneously activating the occupant-controlled switch 26. It should be understood that the first, second, and third manual accelerator pedal activation stimuli are exemplary in nature. Additional methods of detecting the occupant's intention to change the accelerator pedal activation state using the plurality of vehicle sensors 16 are within the scope of the present disclosure.

The exemplary embodiment of block 112 begins at blocks 302, 304, and 306. At block 302, the method 112a for identifying the first manual accelerator pedal activation pedal stimulus begins. At block 302, the controller 14 performs a plurality of accelerator pedal position measurements using the accelerator pedal position sensor 22. After block 302, the method 112a proceeds to block 308.

At block 308, the controller 14 identifies a first accelerator pedal event based on the plurality of accelerator pedal position measurements performed at block 302. In the scope of the present disclosure, the first accelerator pedal event includes the accelerator pedal being actuated to at least a first predetermined accelerator pedal position threshold (e.g., five percent of a maximum accelerator pedal position) for at least a first predetermined time duration (e.g., two hundred milliseconds). In an exemplary embodiment, to identify the first accelerator pedal event, the controller 14 first identifies a first subset of the plurality of accelerator pedal position measurements for which the accelerator pedal position is greater than or equal to the first predetermined accelerator pedal position threshold. If the first subset of the plurality of accelerator pedal position measurements is identified, the controller 14 identifies a first time-difference between a first of the first subset of the plurality of accelerator pedal measurements and a last of the first subset of the plurality of accelerator pedal measurements.

If the first time-difference is less than the first predetermined time duration and/or there exists no first subset of the plurality of accelerator pedal measurements for which the accelerator pedal position is greater than or equal to the first predetermined accelerator pedal position threshold, the first accelerator pedal event is not identified. The method 112a proceeds to block B. If the first time-difference is greater than or equal to the first predetermined time duration, then the first accelerator pedal event is identified, and the method 112a proceeds to block 310.

At block 310, the controller 14 identifies a second accelerator pedal event based on the plurality of accelerator pedal position measurements performed at block 302. In the scope of the present disclosure, the second accelerator pedal event includes the accelerator pedal being released to at least a predetermined minimum accelerator pedal position threshold (e.g., one percent of the maximum accelerator pedal position) for at least a second predetermined time duration (e.g., two hundred milliseconds) after the first accelerator pedal event has occurred. In an exemplary embodiment, to identify the second accelerator pedal event, the controller 14 first identifies a second subset of the plurality of accelerator pedal position measurements for which the accelerator pedal position is less than or equal to the predetermined minimum accelerator pedal position threshold, wherein the second subset occurs after the first subset. If the second subset of the plurality of accelerator pedal position measurements is identified, the controller 14 identifies a second time-difference between a first of the second subset of the plurality of accelerator pedal measurements and a last of the second subset of the plurality of accelerator pedal measurements.

If the second time-difference is less than the second predetermined time duration and/or there exists no second subset of the plurality of accelerator pedal measurements for which the accelerator pedal position is less than or equal to the predetermined minimum accelerator pedal position threshold, the second accelerator pedal event is not identified. The method 112a proceeds to block B. If the second time-difference is greater than or equal to the second predetermined time duration, then the second accelerator pedal event is identified, and the method 112a proceeds to block 312.

At block 312, the controller 14 identifies a third accelerator pedal event based on the plurality of accelerator pedal position measurements performed at block 302. In the scope of the present disclosure, the third accelerator pedal event includes the accelerator pedal being actuated to at least the first predetermined accelerator pedal position threshold for at least the first predetermined time duration after the second accelerator pedal event has occurred. In an exemplary embodiment, to identify the third accelerator pedal event, the controller 14 first identifies a third subset of the plurality of accelerator pedal position measurements for which the accelerator pedal position is greater than or equal to the first predetermined accelerator pedal position threshold, wherein the third subset occurs after the second subset. If the third subset of the plurality of accelerator pedal position measurements is identified, the controller 14 identifies a third time-difference between a first of the third subset of the plurality of accelerator pedal measurements and a last of the third subset of the plurality of accelerator pedal measurements.

If the third time-difference is less than the first predetermined time duration and/or there exists no third subset of the plurality of accelerator pedal measurements for which the accelerator pedal position is greater than or equal to the first predetermined accelerator pedal position threshold, the third accelerator pedal event is not identified. The method 112a proceeds to block B. If the third time-difference is greater than or equal to the first predetermined time duration, then the third accelerator pedal event is identified, and the method 112a proceeds to block 314.

At block 314, the controller 14 determines a first elapsed time between the first accelerator pedal event identified at block 308 and the third accelerator pedal event identified at block 312. In an exemplary embodiment, the first elapsed time is the time-difference between the last of the first subset of the plurality of accelerator pedal measurements and the first of the third subset of the plurality of accelerator pedal measurements. If the first elapsed time is greater than a first predetermined elapsed time threshold (e.g., seven hundred milliseconds), the method 112a proceeds to block B (i.e., enters the standby state at block 106). If the first elapsed time is less than or equal to the first predetermined elapsed time threshold, the method 112a proceeds to block A (i.e., proceeds to block 122 as discussed above).

At block 304, the method 112b for identifying the second manual accelerator pedal activation pedal stimulus begins. At block 304, the controller 14 performs a brake pedal position measurement using the brake pedal position sensor 24. After block 304, the method 112b proceeds to block 316.

At block 316, if the brake pedal position measurement performed at block 304 is less than a predetermined brake pedal position threshold (e.g., five percent of a maximum brake pedal position), the method 112b proceeds to block B. If the brake pedal position measurement is greater than or equal to the predetermined brake pedal position threshold, the method 112b proceeds to block 318.

At block 318, the controller 14 performs an accelerator pedal position measurement using the accelerator pedal position sensor 22. After block 318, the method 112b proceeds to block 320.

At block 320, if the accelerator pedal position measurement performed at block 318 is less than the predetermined minimum accelerator pedal position threshold, the method 112b proceeds to block B. If the accelerator pedal position measurement is greater than or equal to the predetermined minimum accelerator pedal position threshold, the method 112b proceeds to block 322.

At block 322, the controller 14 determines a second elapsed time between the brake pedal position measurement performed at block 304 and the accelerator pedal position measurement performed at block 318. In an exemplary embodiment, the second elapsed time is the time-difference between the brake pedal position measurement performed at block 304 and the accelerator pedal position measurement performed at block 318. If the second elapsed time is greater than a second predetermined elapsed time threshold (e.g., seven hundred milliseconds), the method 112b proceeds to block B. If the second elapsed time is less than or equal to the second predetermined elapsed time threshold, the method 112b proceeds to block A.

At block 306, the method 112c for identifying the third manual accelerator pedal activation pedal stimulus begins. At block 306, the controller 14 performs an accelerator pedal position measurement using the accelerator pedal position sensor 22. After block 306, the method 112c proceeds to block 324.

At block 324, if the accelerator pedal position measurement performed at block 306 is less than the predetermined minimum accelerator pedal position threshold, the method 112c proceeds to block B. If the accelerator pedal position measurement is greater than or equal to the predetermined minimum accelerator pedal position threshold, the method 112c proceeds to block 326.

At block 326, the controller 14 determines a switch activation status of the occupant-controlled switch 26. In the scope of the present disclosure, the switch activation status includes a switch activated status and a switch deactivated status. The switch activated status means that the occupant-controlled switch 26 is activated by the occupant. For example, if the occupant-controlled switch 26 is a normally open switch, the switch activated status occurs when an electrical contact of the occupant-controlled switch 26 is closed. If the occupant-controlled switch 26 is a normally closed switch, the switch activated status occurs when an electrical contact of the occupant-controlled switch 26 is open. If the switch activation status is the switch deactivated status, the method 112c proceeds to block B. If the switch activation status is the switch activated status, the method 112c proceeds to block A.

The system 10 and method 100 of the present disclosure offer several advantages. By using the automatic accelerator pedal activation stimulus to activate the function of the accelerator pedal when the vehicle is not in motion, the potential for acceleration of the vehicle due to unintended actuation of the accelerator pedal is mitigated with minimal impact to the driving experience. Additionally, the occupant may override the automatic accelerator pedal activation method using the manual accelerator pedal activation stimulus, allowing the occupant to take prompt action in an emergency situation.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for controlling acceleration of a vehicle, the system comprising:
a plurality of vehicle sensors; and
a controller in electrical communication with the plurality of vehicle sensors, wherein the controller is programmed to:
determine an accelerator pedal activation state, wherein the accelerator pedal activation state includes an accelerator pedal activated state and an accelerator pedal deactivated state;
identify an accelerator pedal activation stimulus in response to determining that the accelerator pedal activation state is the accelerator pedal deactivated state, wherein the accelerator pedal activation stimulus is identified using the plurality of vehicle sensors; and
determine the accelerator pedal activation state to be the accelerator pedal activated state in response to identifying the accelerator pedal activation stimulus.

2. The system of claim 1, wherein to determine the accelerator pedal activation state, the controller is further programmed to
determine a first elapsed time for which a vehicle speed has been less than or equal to a predetermined minimum vehicle speed threshold using the plurality of vehicle sensors;
compare the first elapsed time to a first predetermined elapsed time threshold; and
determine the accelerator pedal activation state to be the accelerator pedal deactivated state in response to determining that the first elapsed time is greater than or equal to the first predetermined elapsed time threshold.

3. The system of claim 1, wherein to identify the accelerator pedal activation stimulus, the controller is further programmed to:
identify at least one of: a first manual accelerator pedal activation stimulus, a second manual accelerator pedal activation stimulus, a third manual accelerator pedal activation stimulus, and an automatic accelerator pedal activation stimulus.

4. The system of claim 3, the plurality of vehicle sensors further includes an accelerator pedal position sensor, and wherein to identify the accelerator pedal activation stimulus, the controller is further programmed to:
identify the first manual accelerator pedal activation stimulus using at least the accelerator pedal position sensor.

5. The system of claim 4, wherein to identify the first manual accelerator pedal activation stimulus, the controller is further programmed to:
perform a plurality of accelerator pedal position measurements using the accelerator pedal position sensor;
identify a first accelerator pedal event based on the plurality of accelerator pedal position measurements, wherein during the first accelerator pedal event, an accelerator pedal position is greater than or equal to a first predetermined accelerator pedal position threshold for at least a first predetermined time duration;
identify a second accelerator pedal event in response to identifying the first accelerator pedal event, wherein the second accelerator pedal event occurs after the first accelerator pedal event, wherein the second accelerator pedal event is identified based on the plurality of accelerator pedal position measurements, and wherein during the second accelerator pedal event, the accelerator pedal position is less than or equal to a predetermined minimum accelerator pedal position threshold for at least a second predetermined time duration;
identify a third accelerator pedal event in response to identifying the second accelerator pedal event, wherein the third accelerator pedal event occurs after the second accelerator pedal event, wherein the third accelerator pedal event is identified based on the plurality of accelerator pedal position measurements, and wherein during the third accelerator pedal event, the accelerator pedal position is greater than or equal to the first predetermined accelerator pedal position threshold for at least the first predetermined time duration;
determine a first elapsed time between the first accelerator pedal event and the third accelerator pedal event; and
identify the first manual accelerator pedal activation stimulus in response to determining that the first elapsed time is less than or equal to a first predetermined elapsed time threshold.

6. The system of claim 4, wherein the plurality of vehicle sensors further includes a brake pedal position sensor, and wherein to identify the accelerator pedal activation stimulus, the controller is further programmed to:
identify the second manual accelerator pedal activation stimulus using at least the brake pedal position sensor.

7. The system of claim 6, wherein to identify the second manual accelerator pedal activation stimulus, the controller is further programmed to:
perform a brake pedal position measurement using the brake pedal position sensor;
compare the brake pedal position measurement to a predetermined brake pedal position threshold;
perform an accelerator pedal position measurement using the accelerator pedal position sensor in response to determining that the brake pedal position measurement is greater than or equal to the predetermined brake pedal position threshold;
compare the accelerator pedal position measurement to a predetermined minimum accelerator pedal position threshold;
determine a second elapsed time between the brake pedal position measurement and the accelerator pedal position measurement in response to determining that the accelerator pedal position measurement is greater than the predetermined minimum accelerator pedal position threshold;
compare the second elapsed time to a second predetermined elapsed time threshold; and
identify the second manual accelerator pedal activation stimulus in response to determining that the second elapsed time is less than or equal to the second predetermined elapsed time threshold.

8. The system of claim 4, wherein the plurality of vehicle sensors further includes an occupant-controlled switch, and wherein to identify the accelerator pedal activation stimulus, the controller is further programmed to:
identify the third manual accelerator pedal activation stimulus using at least the occupant-controlled switch.

9. The system of claim 8, wherein to identify the third manual accelerator pedal activation stimulus, the controller is further programmed to:
perform an accelerator pedal position measurement using the accelerator pedal position sensor;
compare the accelerator pedal position measurement to a predetermined minimum accelerator pedal position threshold;
determine a switch activation status of the occupant-controlled switch, wherein the switch activation status includes a switch activated status and a switch deactivated status; and
identify the third manual accelerator pedal activation stimulus in response to determining that the accelerator pedal position measurement is greater than or equal to the predetermined minimum accelerator pedal position threshold and that the switch activation status is the switch activated status.

10. The system of claim 3, wherein the plurality of vehicle sensors further includes at least one perception sensor, and wherein to identify the automatic accelerator pedal activation stimulus, the controller is further programmed to:
perform at least one perception measurement using the at least one perception sensor;
determine an obstacle obstruction state based on the at least one perception measurement, wherein the obstacle obstruction state includes an obstructed state and an unobstructed state;
determine a traffic signal state based on the at least one perception measurement, wherein the traffic signal state includes a stop traffic signal state and a go traffic signal state; and
identify the automatic accelerator pedal activation stimulus in response to determining that the obstacle obstruction state is the unobstructed state and the traffic signal state is the go traffic signal state.

11. A method for controlling acceleration of a vehicle, the method comprising:
determining a first elapsed time for which a vehicle speed has been less than or equal to a predetermined minimum vehicle speed threshold using a plurality of vehicle sensors;
comparing the first elapsed time to a first predetermined elapsed time threshold;
determining an accelerator pedal activation state to be an accelerator pedal deactivated state in response to determining that the first elapsed time is greater than or equal to the first predetermined elapsed time threshold;
identifying an accelerator pedal activation stimulus in response to determining that the accelerator pedal activation state is the accelerator pedal deactivated state, wherein the accelerator pedal activation stimulus is identified using the plurality of vehicle sensors; and
determining the accelerator pedal activation state to be an accelerator pedal activated state in response to identifying the accelerator pedal activation stimulus.

12. The method of claim 11, wherein identifying the accelerator pedal activation stimulus further comprises:
identifying at least one of: a manual accelerator pedal activation stimulus and an automatic accelerator pedal activation stimulus.

13. The method of claim 12, wherein the manual accelerator pedal activation stimulus further comprises at least one of:
a first manual accelerator pedal activation stimulus, wherein the first manual accelerator pedal activation stimulus is identified using at least an accelerator pedal position sensor;
a second manual accelerator pedal activation stimulus wherein the second manual accelerator pedal activation stimulus is identified using at least a brake pedal position sensor; and
a third manual accelerator pedal activation stimulus wherein the third manual accelerator pedal activation stimulus is identified using at least an occupant-controlled switch.

14. The method of claim 13, wherein identifying the first manual accelerator pedal activation stimulus further comprises:
performing a plurality of accelerator pedal position measurements using the accelerator pedal position sensor;
identifying a first accelerator pedal event based on the plurality of accelerator pedal position measurements, wherein during the first accelerator pedal event, an accelerator pedal position is greater than or equal to a first predetermined accelerator pedal position threshold for at least a first predetermined time duration;
identifying a second accelerator pedal event in response to identifying the first accelerator pedal event, wherein the second accelerator pedal event occurs after the first accelerator pedal event, wherein the second accelerator pedal event is identified based on the plurality of accelerator pedal position measurements, and wherein during the second accelerator pedal event, the accelerator pedal position is less than or equal to a predetermined minimum accelerator pedal position threshold for at least a second predetermined time duration;
identifying a third accelerator pedal event in response to identifying the second accelerator pedal event, wherein the third accelerator pedal event occurs after the second accelerator pedal event, wherein the third accelerator pedal event is identified based on the plurality of accelerator pedal position measurements, and wherein during the third accelerator pedal event, the accelerator pedal position is greater than or equal to the first predetermined accelerator pedal position threshold for at least the first predetermined time duration;
determining a first elapsed time between the first accelerator pedal event and the third accelerator pedal event; and
identifying the first manual accelerator pedal activation stimulus in response to determining that the first elapsed time is less than or equal to a first predetermined elapsed time threshold.

15. The method of claim 13, wherein identifying the second manual accelerator pedal activation stimulus further comprises:
performing a brake pedal position measurement using the brake pedal position sensor;
comparing the brake pedal position measurement to a predetermined brake pedal position threshold;
performing an accelerator pedal position measurement using the accelerator pedal position sensor in response to determining that the brake pedal position measurement is greater than or equal to the predetermined brake pedal position threshold;
comparing the accelerator pedal position measurement to a predetermined minimum accelerator pedal position threshold;
determining a second elapsed time between the brake pedal position measurement and the accelerator pedal position measurement in response to determining that the accelerator pedal position measurement is greater than the predetermined minimum accelerator pedal position threshold;
comparing the second elapsed time to a second predetermined elapsed time threshold; and
identifying the second manual accelerator pedal activation stimulus in response to determining that the second elapsed time is less than or equal to the second predetermined elapsed time threshold.

16. The method of claim 13, wherein identifying the third manual accelerator pedal activation stimulus further comprises:
performing an accelerator pedal position measurement using the accelerator pedal position sensor;
comparing the accelerator pedal position measurement to a predetermined minimum accelerator pedal position threshold;
determining a switch activation status of the occupant-controlled switch, wherein the switch activation status includes a switch activated status and a switch deactivated status; and
identifying the third manual accelerator pedal activation stimulus in response to determining that the accelerator pedal position measurement is greater than or equal to the predetermined minimum accelerator pedal position threshold and that the switch activation status is the switch activated status.

17. The method of claim 12, wherein identifying the automatic accelerator pedal activation stimulus further comprises:
performing at least one perception measurement using at least one perception sensor;
determining an obstacle obstruction state based on the at least one perception measurement, wherein the obstacle obstruction state includes an obstructed state and an unobstructed state;
determining a traffic signal state based on the at least one perception measurement, wherein the traffic signal state includes a stop traffic signal state and a go traffic signal state; and
identifying the automatic accelerator pedal activation stimulus in response to determining that the obstacle obstruction state is the unobstructed state and the traffic signal state is the go traffic signal state.

18. A system for controlling acceleration of a vehicle, the system comprising:
a plurality of vehicle sensors comprising:
an accelerator pedal position sensor;
a brake pedal position sensor;
an occupant-controlled switch; and
at least one perception sensor; and
a controller in electrical communication with the plurality of vehicle sensors, wherein the controller is programmed to:
determine a first elapsed time for which a vehicle speed has been less than or equal to a predetermined minimum vehicle speed threshold using the plurality of vehicle sensors;
compare the first elapsed time to a first predetermined elapsed time threshold;
determine an accelerator pedal activation state to be an accelerator pedal deactivated state in response to determining that the first elapsed time is greater than or equal to the first predetermined elapsed time threshold; and
identify an accelerator pedal activation stimulus in response to determining that the accelerator pedal activation state is the accelerator pedal deactivated state, wherein the accelerator pedal activation stimulus includes at least one of:
a manual accelerator pedal activation stimulus, wherein the manual accelerator pedal activation stimulus is identified using at least one of: the accelerator pedal position sensor, the brake pedal position sensor, and the occupant-controlled switch;
an automatic accelerator pedal activation stimulus, wherein the automatic accelerator pedal activation stimulus is identified using at least the at least one perception sensor; and
determine the accelerator pedal activation state to be an accelerator pedal activated state in response to identifying the accelerator pedal activation stimulus.

19. The system of claim 18, wherein the manual accelerator pedal activation stimulus further comprises at least one of:
a first manual accelerator pedal activation stimulus, wherein the first manual accelerator pedal activation stimulus is identified using at least the accelerator pedal position sensor;
a second manual accelerator pedal activation stimulus, wherein the second manual accelerator pedal activation stimulus is identified using at least the brake pedal position sensor; and
a third manual accelerator pedal activation stimulus, wherein the third manual accelerator pedal activation stimulus is identified using at least the occupant-controlled switch.

20. The system of claim 19, wherein to identify the automatic accelerator pedal activation stimulus, the controller is further programmed to:
perform at least one perception measurement using the at least one perception sensor;
determine an obstacle obstruction state based on the at least one perception measurement, wherein the obstacle obstruction state includes an obstructed state and an unobstructed state;
determine a traffic signal state based on the at least one perception measurement, wherein the traffic signal state includes a stop traffic signal state and a go traffic signal state; and
identify the automatic accelerator pedal activation stimulus in response to determining that the obstacle obstruction state is the unobstructed state and the traffic signal state is the go traffic signal state.
